(19) United States
(12) Patent Application Publication
(10) Pub. No.: US 2026/0219195 A1
(43) Pub. Date: Jul. 30, 2026

(54) DROPLET EJECTION ANALYZER, DROPLET EJECTION ANALYSIS SYSTEM, DROPLET EJECTION ANALYSIS METHOD, AND STORAGE MEDIUM

(71) Applicant: Konica Minolta, Inc., Tokyo (JP)

(72) Inventors: Keishi SUZUKI, Tokyo (JP); Naomi WATANABE, Tokyo (JP)

(21) Appl. No.: 19/455,967

(22) Filed: Jan. 22, 2026

(30) Foreign Application Priority Data
Jan. 27, 2025 (JP) 2025-011238

(51) Int. Cl. G01N 21/85; B41J 3/44; G06T 7/20; G06T 7/62; G06T 7/70

(52) U.S. Cl. CPC G01N 21/85; B41J 3/44; G06T 7/20; G06T 7/62; G06T 7/70

(57) ABSTRACT

A droplet ejection analyzer includes a hardware processor that: acquires image data of a droplet ejected by a droplet ejector from an imaging unit; acquires data of each droplet by performing image processing on the image data; performs analysis processing based on the data; and estimates a behavior of each droplet based on an analysis result of the analysis processing.

### CROSS-REFERENCE TO RELATED APPLICATIONS

The entire disclosure of Japanese Patent Application No. 2025-011238 filed on Jan. 27, 2025 is incorporated herein by reference in its entirety.

### BACKGROUND OF THE INVENTION

### Technical Field

The present disclosure relates to a droplet ejection analyzer, a droplet ejection analysis system, a droplet ejection analysis method, and a storage medium.

### Description of Related Art

Conventionally, there has been known a droplet ejection apparatus including a droplet ejection section that ejects droplets toward an ejection target. The droplets ejected by the droplet ejection section are roughly classified into two types of main droplets and satellites. The satellite is minute with respect to the main droplet. The satellite becomes mist floating in the air without landing on the ejection target due to the influence of the atmosphere or the like, and may cause an ejection failure by adhering to the nozzle opening surface of the droplet ejection section. Since the degree of mist generation changes according to conditions such as the physical property of the liquid and the ejection parameters, it is preferable to set conditions under which satellites are as unlikely to be generated as possible.

Therefore, for example, Japanese Unexamined Patent Publication No. 2024-124481 describes that conditions under which mist is generated are specified using a droplet observation device which images droplets ejected by a droplet ejection section by a drop watcher and measures droplet volumes, ejection speeds, angles, and the like of the droplets.

### SUMMARY OF THE INVENTION

However, according to the invention of Japanese Unexamined Patent Publication No. 2024-124481, whether or not mist is generated is confirmed by observation. Therefore, the recognition of the occurrence of mist varies depending on the checker, and it is not possible to objectively verify the conditions for suppressing the occurrence of mist.

The present disclosure has been made in view of such circumstances. It is an object of the present invention to provide a droplet ejection analyzer, a droplet ejection analysis system, a droplet ejection analysis method, and a storage medium that can objectively verify conditions for suppressing generation of mist.

To achieve at least one of the abovementioned objects, according to an aspect of the present invention,
droplet ejection analyzer reflecting one aspect of the present invention comprises: a hardware processor that:
acquires image data of a droplet ejected by a droplet ejector from an imaging unit;
acquires data of each droplet by performing image processing on the image data;
performs analysis processing based on the data; and
estimates a behavior of each droplet based on an analysis result of the analysis processing.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention, wherein:

FIG. 1 is a schematic configuration diagram of a droplet ejection analysis system;

FIG. 2 is a block diagram of a droplet ejection analysis system;

FIG. 3 is an example of table data of droplet;

FIG. 4 is an example of a graph illustrating a deceleration model of a droplet based on an equation of motion for each particle diameter;

FIG. 5 is an example of a histogram of droplet particle diameter and number;

FIG. 6 is an example of a graph of the particle diameter and the liquid amount of droplet;

FIG. 7 is an example of a graph illustrating a frequency distribution of reach distances of droplet;

FIG. 8 is an example of a contour plot of velocity of droplet and an estimated mist amount; and

FIG. 9 is a flowchart of the droplet ejection analysis processing.

### DETAILED DESCRIPTION

Hereinafter, one or more embodiments of the present invention will be described with reference to the drawings. However, the scope of the invention is not limited to the disclosed embodiments.

The following description describes one or more embodiments of the present disclosure with reference to the drawings. The effects and features of the embodiment of the present disclosure will be understood from the following detailed description and the drawings. The following detailed description and drawings are provided for illustration only and do not limit the scope of the present disclosure.

### [Overall Configuration of Droplet Ejection Analysis System]

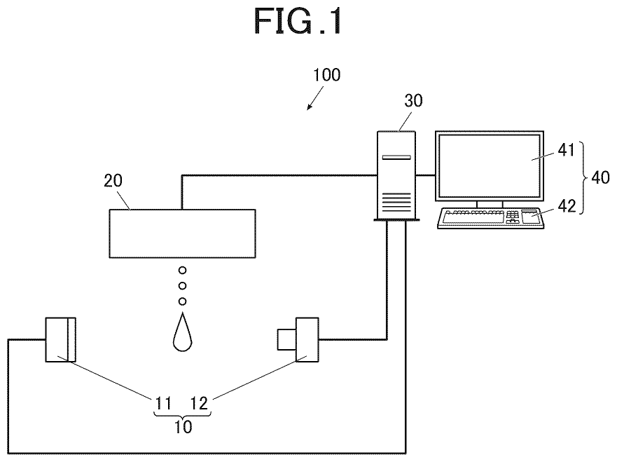

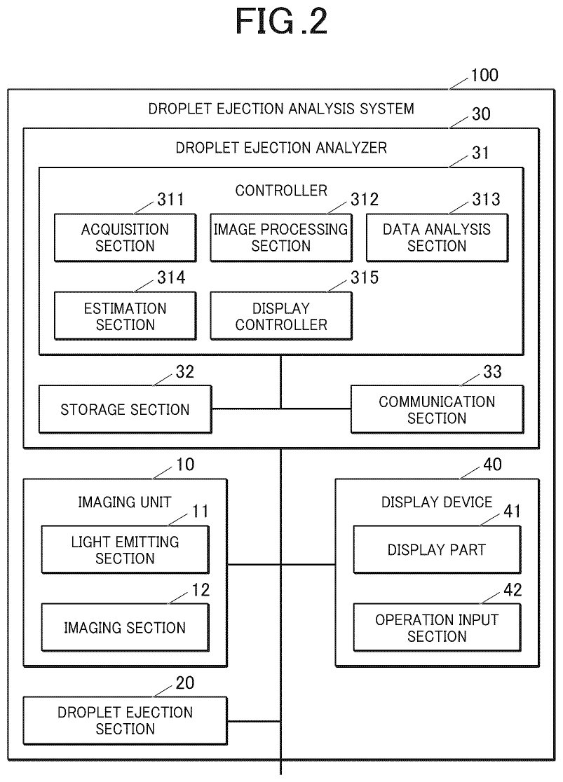

FIG. 1 is a schematic configurational view of an droplet ejection analysis system (hereinafter, analysis system) 100 including a droplet ejection analyzer (hereinafter, analysis apparatus) 30 according to the present embodiment. FIG. 2 is a block diagram illustrating a functional configuration of the analysis system 100 according to the present embodiment.

The analysis system 100 includes an imaging unit 10, a droplet ejection section (droplet ejector) 20, an analysis apparatus 30, and a display device 40.

### (Imaging Unit)

Under the control of the controller 31 which will be described later, the imaging unit 10 images a droplet ejected by the droplet ejection section 20 and transmits image data to the analysis apparatus 30. The imaging unit 10 includes a light emitting section 11 and an imaging section 12. The light emitting section 11 is, for example, a strobe, and emits light in synchronization with a droplet ejection cycle of the droplet ejection section 20 under the control of the controller 31. In addition, the imaging section 12 is, for example, a charge coupled device (CCD) camera, and receives the light emitted by the light emitting section 11 to image the droplet.

The light emitting section 11 is not limited to a strobe, and may be a light emitting diode (LED) or the like. Further, the imaging section 12 is not limited to the CCD camera, and may be a complementary metal oxide semiconductor (CMOS) camera or the like. However, it is preferable to use a strobe as the light emitting section 11 and a CCD camera as the imaging section 12 because the imaging unit 10 can be configured at a relatively low cost.

### (Droplet Ejection Section)

The droplet ejection section 20 is, for example, an inkjet head which includes a plurality of pressure chambers which store ink, piezoelectric elements which are provided on wall surfaces of the pressure chambers, and a plurality of nozzles which respectively communicate with the plurality of pressure chambers and in which opening portions are provided on a lower surface of the droplet ejection section 20, and which ejects ink droplets. When a drive signal for deforming the piezoelectric element is input from the controller 31, the pressure chamber is deformed to change the pressure in the pressure chamber, with the result that the droplet ejection section 20 ejects a droplet from the nozzle.

The droplets ejected by the droplet ejection section 20 are not limited to ink droplets, and any droplets such as a pretreatment liquid and a coagulant may be ejected. The configuration in which the droplet ejection section 20 ejects droplets is also not limited to that described above.

### (Droplet Ejection Analyzer)

The analysis apparatus 30 is connected to the imaging unit 10, the droplet ejection section 20, and the display device 40 via a network (not illustrated). The analysis apparatus 30 performs various kinds of analysis processing on the basis of image data of droplets ejected by the droplet ejection section 20, which is imaged by the imaging unit 10. The analysis apparatus 30 includes a controller 31, a storage section 32, and a communication section 33.

### {Controller}

The controller 31 (hardware processor) includes a CPU (Central Processing Unit), a RAM (Random Access Memory), and the like

The analysis apparatus 30 is a processor (computer) that integrally controls each unit constituting the analysis apparatus 30 and the analysis system 100. The CPU reads a program, such as an application program, stored in the storage section 32, loads the program to the RAM, and executes the program to perform various types of processing. In particular, the controller 31 mainly functions as an acquisition section 311, an image processing section 312, a data analysis section 313, an estimation section 314, and a display controller 315 by the CPU executing the program.

### <Acquisition Section>

The acquisition section 311 acquires the image data of the droplet imaged and transmitted by the imaging section 12. In addition, when information (the mass of the droplet, the mass density, the charge amount, the viscous resistance of air, the vector quantity of the flow velocity vector field, the vector quantity of the electric field, the distance to the ejection target, and the like) necessary for the data analysis by the data analysis section 313 is input to the operation input section 42 described later, the acquisition section 311 acquires it.

### <Image Processing Section>

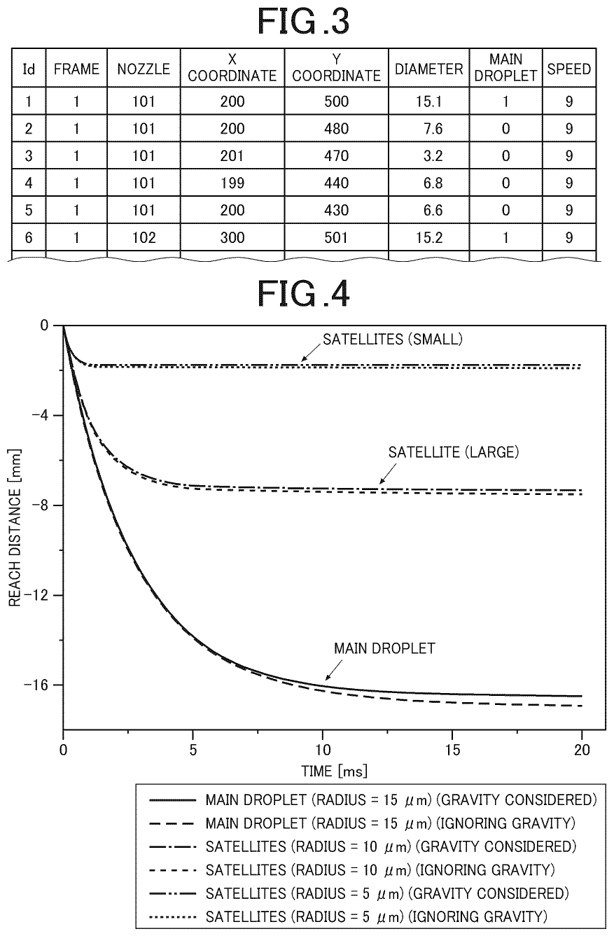

The image processing section 312 performs image processing on the image data acquired by the acquisition section 311 from the imaging unit 10 to acquire data such as the particle diameter and the velocity of each droplet. Next, as illustrated in FIG. 3, the image processing section 312 creates table data including information such as the particle diameter and velocity of each droplet, from which nozzle the droplet has been ejected, and whether the droplet is a main droplet or a satellite droplet, and stores the table data in the storage section 32.

### <Data Analysis Section>

The data analysis section 313 performs various kinds of analysis processing on the basis of data such as the particle diameter and the velocity of the droplet obtained by the image processing section 312.

For example, based on the table data created by the image processing section 312, the data analysis section 313 sets a class of the particle diameter based on the number and the range of the data, and creates a frequency distribution table of the particle diameter of the droplet.

In addition, a flying distance of a droplet ejected from the droplet ejection section 20 is changed by being decelerated according to air resistance, and such an influence of the air resistance becomes greater as a particle diameter of the droplet is smaller. In addition, a flying distance of a droplet ejected from the droplet ejection section 20 becomes shorter as an ejection speed becomes slower.

Specifically, the deceleration of the droplet can be expressed by the following model formula using an equation of motion. Note that Formula (1) is a model expression when the gravity is not taken into consideration, and Formula (2) is a model expression when the gravity is taken into consideration. Furthermore, in the following, k: Viscous resistance of air, v₀: velocity of droplet (initial velocity), m: The mass of the droplet.

$$[ Formula 1 ]$$

$$\begin{matrix}m \ddot{x} = - k \dot{x} & x ( t ) = \frac{{v}_{0} m}{k} ( 1 - {e}^{- \frac{k}{m} t} )\end{matrix} \qquad ( 1 )$$

$$[ Formula 2 ]$$

$$\begin{matrix}m \ddot{x} = - k \dot{x} + mg & x ( t ) = \frac{mg}{k} t + \frac{m}{k} ( {v}_{0} - \frac{mg}{k} ) ( 1 - {e}^{- \frac{k}{m} t} )\end{matrix} \qquad ( 2 )$$

FIG. 4 illustrates deceleration models of droplets for respective particle diameters, using Formula (1) and the model formula of Formula (2), respectively. As illustrated in FIG. 4, whether the gravity is considered or not, there is almost no difference in the calculated reach distance of the droplet. Therefore, in the following description, the flight distance based on Formula (1) in which the gravity is not considered is set as the reach distance.

Here, since the droplet is a sphere, n: viscosity coefficient of air, r: When a radius of the droplet is defined, viscous resistance k of air can be expressed as in the following Formula (3).

$$[ Formula 3 ]$$

$$k = 6 πη r \qquad ( 3 )$$

In addition, the p: Assuming that the mass density of liquid, the mass m of a droplet can be expressed as in the following Formula (4).

$$[ Formula 4 ]$$

$$m = \frac{4}{3} π {r}^{3} p \qquad ( 4 )$$

The following Formula (5), which is obtained by substituting Formula (3) and Formula (4) into formula (1), is an expression for the velocity v₀ of the droplet and dₛᵤₚ including the particle diameter (radius r): the reach distance of the droplet. Therefore, the data analysis section 313 can calculate the reach distance of the droplet based on the velocity and the particle diameter of the droplet.

$$[ Formula 5 ]$$

$${d}_{sup} = \frac{{ν}_{0} m}{k} = \frac{2 ρ {r}^{2} {v}_{0}}{9 η} \qquad ( 5 )$$

Note that the equation of motion is not limited to the Formula (1) and (2), and the following Formula (6) using information on the electrical conductivity and dielectric constant of the liquid, the airflow, and the electric field may be used. In Formula (6), V (x) is a vector amount of a flow velocity vector field of the air, E (x) is a vector amount of an electric field in a space in which the droplet is ejected, and q: the charge amount of the droplet.

$$[ Formula 6 ]$$

$$m \ddot{x} = - k ( \dot{x} — V ( x ) ) + mg + qE ( x ) \qquad ( 6 )$$

### <Estimation Section>

The estimation section 314 determines whether the droplet lands on the ejection target or is scattered in the air based on a preset value of the distance from the lower surface of the droplet ejection section 20 to the ejection target and the reach distance of each droplet calculated by the data analysis section 313.

Specifically, in a case where the reach distance of the droplet is shorter than a set value, the droplet does not land on the ejection target and becomes mist scattering in the air. On the other hand, when the reach distance of the droplet is larger than the set value, the droplet lands on the ejection target. As described above, the estimation section 314 determines, based on the magnitude relation between the reach distance of a droplet and the set value, whether the droplet lands on the ejection target or is scattered in the air without landing thereon.

Furthermore, when the conveyance velocity of the ejection target is set, the estimation section 314 estimates the landing position on the ejection target by taking into account the influence of the conveyance speed.

### <Display Controller>

The display controller 315 transmits a predetermined display control signal to the display device 40 based on various programs and various data stored in the storage section 32, and causes the display part 41 to be described later to display statistical data based on the analysis result of the data analysis section 313.

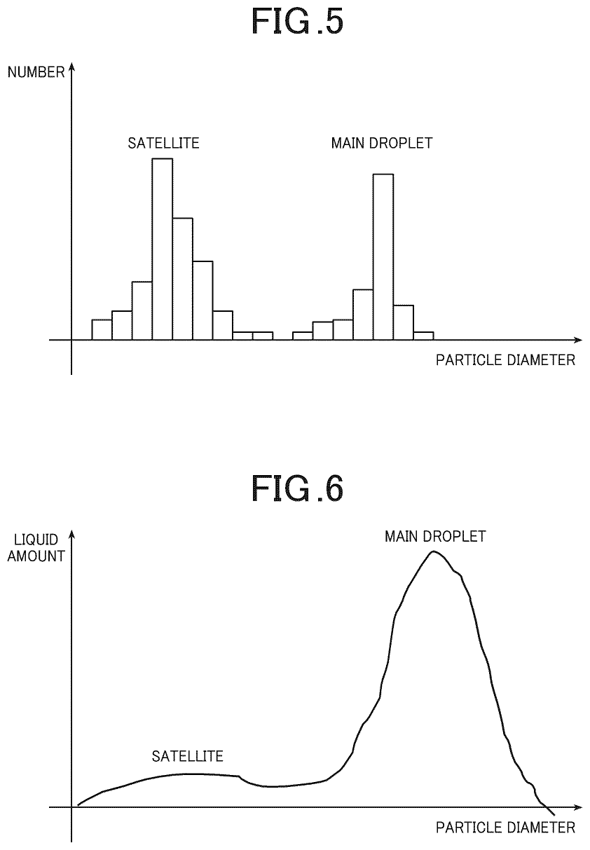

For example, the display controller 315 creates a histogram in which the X axis represents the particle diameter and the Y axis represents the number of droplets as shown in FIG. 5 on the basis of the frequency distribution table created by the data analysis section 313, and causes the display part 41 to display the histogram. According to FIG. 5, it is found that two peaks of the main droplet and the satellite appear in the distribution of the particle diameter of the droplets. By displaying the histogram as shown in FIG. 5 on the display part 41, the user can intuitively recognize the distribution of the particle diameter of the main droplet and the satellite. 30

Based on the analysis result of the data analysis section 313, the display controller 315 creates a graph in which the X axis represents the particle diameter and the Y axis represents the liquid amount for each particle diameter as shown in FIG. 6, and displays the graph on the display part 41. According to FIG. 6, the liquid amounts of the main droplet and the satellite can be seen. By displaying the graph as shown in FIG. 6 on the display part 41, the user can intuitively recognize whether the droplet ejection section 20 can eject a sufficient amount of main droplets.

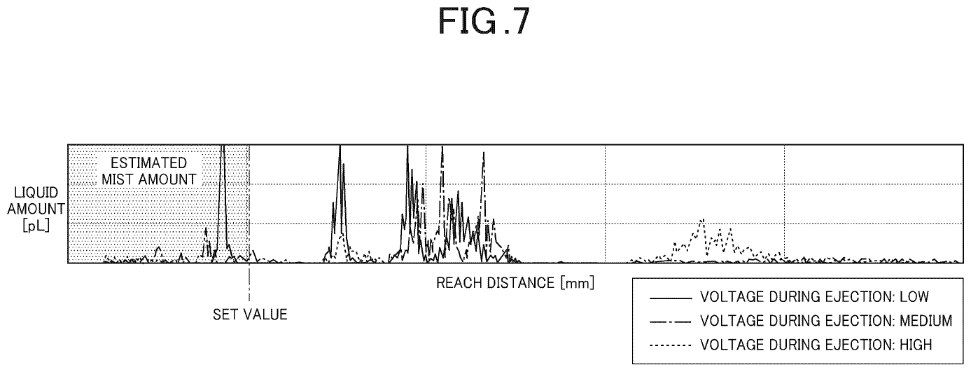

In addition, when the data analysis section 313 calculates the reach distance of each droplet, the display controller 315 may create a frequency distribution of the reach distances of droplets calculated by the data analysis section 313 as shown in FIG. 7 and cause the display part 41 to display the frequency distribution.

In addition, when a set value of the distance between the lower surface of the droplet ejection section 20 and the ejection target is set, the display controller 315 may highlight an area less than the set value in the frequency distribution as shown in FIG. 7. With this configuration, it is possible to visualize the estimated amount of mist (estimated mist amount) that is a droplet not landing on the ejection target.

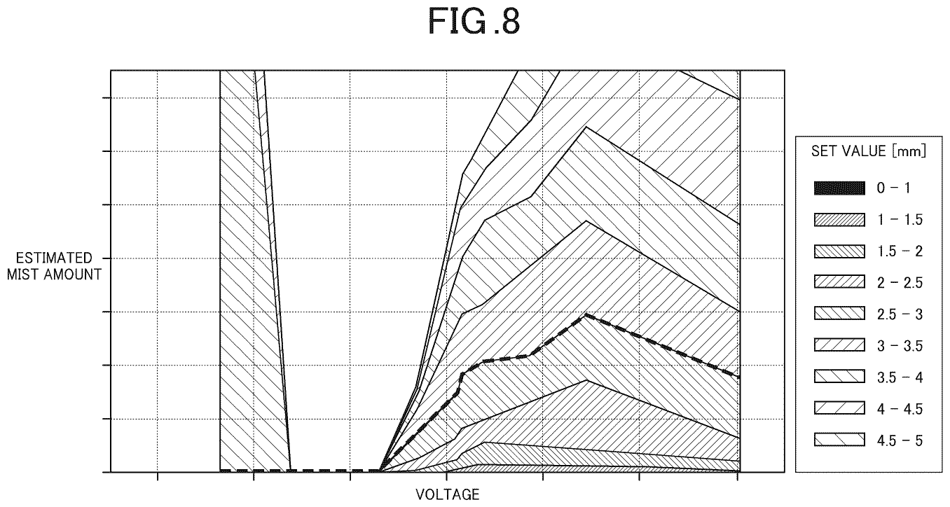

Further, in the above-described configuration, as shown in FIG. 8, the display controller 315 may cause the display part 41 to display a contour plot in which the X axis represents the voltage of the drive signal (that is, the velocity of the droplet) and the Y axis represents the estimated mist amount. From the results illustrated in FIG. 8, it is found that the estimated mist amount increases as the set value of the distance between the lower surface of the droplet ejection section 20 and the ejection target increases. It is also found that the estimated mist amount increases as the voltage at the time of ejection increases and the velocity of droplet increases to a predetermined value.

Note that at this time, for example, it is particularly preferable that the display controller 315 causes the display part 41 to display, for comparison, contour plots in a case where the physical property of the liquid and the ejection parameters are made different from each other, because it becomes possible to make a comparison and study as to whether the generation of mist can be further suppressed under any of the conditions.

The display controller 315 may cause the display part 41 to display the analysis result of the main droplet and the satellite separately.

### (Storage Section)

The storage section 32 includes a hard disk drive (HDD) and a nonvolatile semiconductor memory. The storage section 32 stores various programs to be executed by the controller 31, various data, and the like. The storage section 32 also stores table data generated by the image processing section 312, a frequency distribution table generated by the data analysis section 313, and the like. At least a part of the various programs may be stored in the ROM or the like of the controller 31.

### (Communication Section)

The communication section 33 includes a communication module and the like. The communication section 33 transmits and receives various signals and various data to and from the imaging unit 10, the droplet ejection section 20, the display device 40, and other devices connected thereto via the network.

### (Display Device)

The display device 40 is, for example, a personal computer including a display part 41 which is a display and an operation input section 42 which is a keyboard, a mouse, or the like. The analysis apparatus 30 may include a configuration corresponding to the display part 41 and the operation input section 42. In this case, the analysis system 100 may not include the display device 40.

### [Droplet Ejection Analysis Processing]

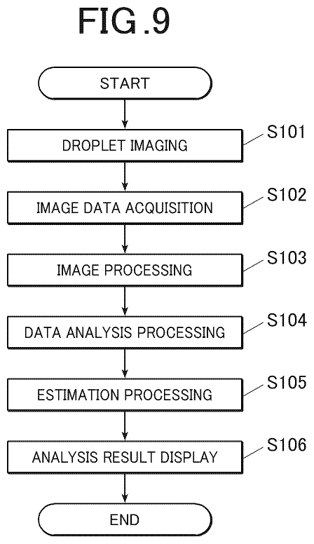

A series of flows of droplet ejection analysis processing in such a droplet ejection analysis system 100 will be described with reference to the flowchart of FIG. 9.

First, the controller 31 of the analysis apparatus 30 controls the imaging unit 10 and the droplet ejection section 20 to cause the imaging unit 10 to image a droplet ejected by the droplet ejection section 20 under set predetermined conditions (step S101).

The acquisition section 311 acquires image data from the imaging unit 10 (step S102; acquiring step). The acquisition section 311 passes the obtained image data to the image processing section 312 to perform image processing (step S103; image processing step).

For example, the image processing section 312 measures the size of each of the main droplet and the satellite included in the acquired image data, and specifies the nozzle of the ejection source. The image processing section 312 also measures the ejection speed of predetermined main droplets and satellites on the basis of a plurality of consecutive pieces of image data. The image processing section 312 creates table data as illustrated in FIG. 3 based on these data.

The data analysis section 313 performs various types of data analysis based on the table created by the image processing section 312 (step S104; data analysis step). In particular, the data analysis section 313 calculates the reach distance of each droplet as necessary. Then, the estimation section 314 estimates the behavior of the droplets based on the reach distances calculated by the data analysis section 313 and the set values of the distances from the droplet ejection section 20 to the ejection target set in advance (step S105; estimation step).

Upon receiving an instruction to display statistical data from the user via the operation input section 42, the display controller 315 creates various kinds of statistical data as shown in FIGS. 5 to 8 based on the received instruction content, the processing result of the image processing section 312, and the analysis result of the data analysis section 313. Next, the display controller 315 causes the display part 41 to display the created statistics data (step S106; display control step). Note that the control of step S106 may be automatically performed at the time when the acquisition section 311 acquires the image data from the imaging unit 10 without receiving the instruction by the operation input section 42.

### Effects of Embodiment

As described above, the droplet ejection analyzer 30 according to the present embodiment includes the acquisition section 311 that acquires the image data of the droplets ejected by the droplet ejection section 20 from the imaging unit 10. In addition, the droplet ejection analyzer 30 includes an image processing section 312 that acquires data of each droplet by performing image processing on image data. The droplet ejection analyzer 30 further includes a data analysis section 313 that performs analysis processing on the basis of the data and estimates the behavior of each droplet on the basis of the analysis result. With this structure, the behavior of the droplets, that is, whether or not the droplets have become mist is estimated on the basis of the data on the droplets, and therefore, physical property of the liquid and ejection parameters for suppressing the generation of mist can be objectively verified.

Note that although an example in which an HDD is used as a computer-readable medium for the program according to the present disclosure has been disclosed above, it is not limited to this example. As another computer-readable medium, a portable recording medium such as a CD-ROM can be applied. Furthermore, a carrier wave is also applied as a medium for providing data of the program according to the present disclosure via a communication line.

According to the present embodiment, it is possible to objectively verify the conditions for suppressing the generation of mist.

Although embodiments of the present invention have been described and illustrated in detail, the disclosed embodiments are made for purposes of illustration and example only and not limitation. The scope of the present invention should be interpreted by terms of the appended claims.

What is claimed is:

1. A droplet ejection analyzer comprising a hardware processor that:
acquires image data of a droplet ejected by a droplet ejector from an imaging unit;
acquires data of each droplet by performing image processing on the image data;
performs analysis processing based on the data; and
estimates a behavior of each droplet based on an analysis result of the analysis processing.

2. The droplet ejection analyzer according to claim 1, wherein the hardware processor estimates whether or not each droplet reaches an ejection target.

3. The droplet ejection analyzer according to claim 2, wherein
the hardware processor calculates a reach distance of each droplet based on data of a particle diameter and a velocity of each droplet among the data, and
the hardware processor estimates whether or not each droplet reaches the ejection target based on the reach distance and a set value of a distance between the droplet ejector and the ejection target.

4. The droplet ejection analyzer according to claim 3, wherein the hardware processor calculates a deceleration amount of the droplet ejected from the droplet ejector based on following Expression 1, where k is a viscous resistance of air, V₀ is a velocity of the droplet, and m is a mass of the droplet:
$$x ( t ) = {V}_{0} m / k ( 1 - e ⋀ ( - k t / m ) ) . \qquad Expression ( 1 )$$

5. The droplet ejection analyzer according to claim 4, wherein when a mass density of liquid before being formed into the droplet is defined as p, a radius of the droplet is defined as r, and a viscosity coefficient of air is defined as η, the hardware processor calculates a reach distance dₛᵤₚ of the droplet ejected from the droplet ejector based on following Expression (2) in which gravity is not considered:
$${d}_{sup} = {V}_{0} m / k = 2 ρ {r}^{2} {V}_{0} / 9 η . \qquad Expression ( 2 )$$

6. The droplet ejection analyzer according to claim 5, wherein the hardware processor estimates that a droplet whose calculated reach distance dₛᵤₚ is smaller than the set value is mist.

7. The droplet ejection analyzer according to claim 2, wherein the hardware processor estimates a landing position of each droplet on the ejection target based on data on a particle diameter and a velocity of each droplet among the data and an assumed value of a conveyance speed of the ejection target.

8. The droplet ejection analyzer according to claim 1, wherein
the hardware processor acquires a mass density of liquid before being formed into the droplet, and
the hardware processor estimates the behavior of each droplet based on the mass density of the liquid.

9. The droplet ejection analyzer according to claim 1, wherein
the hardware processor acquires a viscosity coefficient of air, and
the hardware processor estimates the behavior of each droplet based on the viscosity coefficient of air.

10. The droplet ejection analyzer according to claim 1, wherein
the hardware processor acquires an electrical conductivity and/or a dielectric constant of liquid before being formed into the droplet, and
the hardware processor estimates the behavior of each droplet based on the electrical conductivity and/or the dielectric constant of the liquid.

11. The droplet ejection analyzer according to claim 1, wherein
the hardware processor acquires information on an airflow, and
the hardware processor estimates the behavior of each droplet based on the airflow.

12. The droplet ejection analyzer according to claim 1, wherein
the hardware processor acquires information on an electric field in a space in which the droplet ejector ejects the droplet, and
the hardware processor estimates the behavior of each droplet based on a mass density of liquid before being formed into the droplet.

13. A droplet ejection analysis system comprising:
the droplet ejection analyzer according to claim 1;
a droplet ejector that ejects a droplet to an ejection target; and
an imaging unit that images the droplet ejected by the droplet ejector.

14. A droplet ejection analysis method using a droplet ejection analyzer, the method comprising:
acquiring, from an imaging unit, image data of a droplet ejected by a droplet ejector;
acquiring data of each droplet by performing image processing on the image data;
performing analysis processing based on the data; and
estimating a behavior of each droplet based on an analysis result of the analysis processing.

15. A non-transitory computer-readable storage medium storing a program that causes a computer of a droplet ejection analyzer to perform
acquiring, from an imaging unit, image data of a droplet ejected by a droplet ejector;
acquiring data of each droplet by performing image processing on the image data;
performing analysis processing based on the data; and
estimating a behavior of each droplet based on an analysis result of the analysis processing.
